(19) United States
(12) Patent Application Publication
(10) Pub. No.: US 2022/0206183 A1
(43) Pub. Date: Jun. 30, 2022

(54) Conveyor Module, Small Fragments of Which are Magnetically and X-Ray Detectable

(71) Applicant: Safari Belting Systems, Inc., Olathe, KS (US)

(72) Inventors: Christopher J. Smith, Leawood, KS (US); Julia H. Smith, Leawood, KS (US); Johnson C. Watkins, Newark, DE (US)

(73) Assignee: Safari Belting Systems, Inc., Olathe, KS (US)

(21) Appl. No.: 17/698,958

(22) Filed: Mar. 18, 2022

Related U.S. Application Data
(63) Continuation-in-part of application No. 17/376,123, filed on Jul. 14, 2021.
Application No. 17/376,123 is a continuation-in-part of application No. 17/206,663, filed on Mar. 19, 2021.
(60) Provisional application No. 62/991,872, filed on Mar. 19, 2020.

(51) Int. Cl. G01V 15/00; G01V 5/00; G01V 3/08; B29C 70/46; B29C 70/00; C08L 61/02; C08K 3/30; C08K 3/08

(52) U.S. Cl. CPC G01V 15/00; G01V 5/0016; G01V 3/08; B29C 70/465; B29L 2031/709; C08L 61/02; C08K 3/30; C08K 3/08; B29C 70/003

(57) ABSTRACT

A conveyor module, small fragments of which are detectable by X-ray and/or magnetic sensors, is formed from a compounded mixture of a polyketone resin, a ferrous metal powder, and, optionally, a barium sulfate powder. The ferrous metal powder is preferably 400 series stainless steel powder, or alternatively, a 300 series stainless steel powder, iron powder, or other iron alloy powder.

### CROSS-REFERENCE TO RELATED ART

This application is a continuation-in-part patent application of prior application Ser. No. 17/376,123, filed Jul. 14, 2021, which is a continuation-in-part patent application of prior application Ser. No. 17/206,663, filed Mar. 19, 2021, which application claims the benefit of U.S. Provisional Application No. 62/991,872, filed Mar. 19, 2020, all of which applications are hereby incorporated herein by reference, in their entirety.

### TECHNICAL FIELD OF THE INVENTION

The invention relates generally to a conveyor system, and, more particularly, to a conveyor system in which conveyor modules are manufactured from a mixture of a thermoplastic polymer, stainless steel powder, and, optionally, barium sulfate powder, small fragments of which module are X-Ray and/or magnetically detectable.

### BACKGROUND OF THE INVENTION

Low friction, wear resistant polymeric materials are used in modular plastic conveyor belt modules in numerous industries. In the meat and food product packaging industry, most conventional modular plastic conveyor belt modules are molded using polypropylene (“PP”), polyethylene (“PE”), or polyoxymethylene (“POM” aka acetal). The environment and use conditions of the conveyor dictate which polymer is best suited for a given conveyor. Environmental conditions include ambient temperature, temperature swings such as hot to cold, humidity, immersion in liquid treatment baths, and chemical cleaning solutions. Use conditions can be described as speed of the conveyor, direction of travel and contact pressure of the conveyor belt module against contact surfaces. Conveyor belt modules are exemplified in U.S. Pat. No. 7,134,545 B1, issued on Nov. 14, 2006, to Chris Smith, and U.S. Pat. No. 10,773,896 B1, issued on Sep. 15, 2020, to Chris Smith, both of which patents are incorporated herein by reference in their entirety.

Selecting the best polymer for a conveyor weighs the pros and cons of the interaction of that polymer with the conditions to which it will be subjected. For example, it is known to those skilled in the art that:
Polyamides, polyacetal and polyester have various coefficient of friction ratings which are ideal in sliding or rubbing applications like conveyors depending on product being conveyed.
Polyamides absorb 4-8% moisture and will swell in physical size with moisture.
Polyacetal is chemically degraded when exposed to low pH (or acidic) solutions.
PBT polyester chemically degrades in the presence of moisture above 80° C.

Among the many end use markets where polymeric conveyors are used is the food processing segment for both human and animal foodstuffs, referred to herein as the “protein market”. The protein market includes processing plants for the conversion of chickens, hogs, cattle, and fish into consumer products. Food safety to prevent foodborne illness and to prevent foreign material contamination is of utmost importance.

Recent advances in sanitizing techniques and sanitizing chemical agents have positively affected food safety but have had an adverse effect on the integrity and longevity of plastic conveyors. What has occurred is that the newer sanitizers now in use are lower in pH, and contain chemical oxidizers like hydrogen peroxide and peroxy acetic acid. Where before polyacetal was widely used as the polymer of choice in protein market conveyors, the rise of acidic oxidizers has rendered polyacetal nearly unusable because of its chemical incompatibility with both acidic agents and its high susceptibility to oxidative attack.

When polymers are chemically attacked, they lose their mechanical integrity, including tensile strength and impact resistance. Material science has described the loss of tensile properties and/or loss of impact resistance as embrittlement. A brittle polymer will fracture or shatter, generating small pieces of plastic debris, when external stresses are placed on it.

Conveyor modules manufactured from such polymers may, over time, through normal wear, cutting directly on modules, neglect, and/or by incidental impact, degenerate such that small fragments and particulates from the conveyor modules become integrated into the food products. These contaminants can be dangerous as choking hazards. If a piece of belt breaks off and gets into the food chain, the costs to the food processor can be in the 10's of millions of dollars. All the product from a particular production run must be recalled and disposed at the processor's expense. Recently, the USDA issued new guidelines for “foreign body contamination” recalls and the steps necessary to comply. The example the USDA used was what would happen if a piece of a modular plastic conveyor belt broke off and got into the food chain. This is a huge issue that is costing food companies billions of dollars each year.

Additionally, in industries such as pharmaceutical processing, the plastics may contain organometallic catalysts and plasticizers that can degrade the pharmaceutical product. Food contaminates such as wood and cloth and conveyor contaminates can be harmful to humans and/or animals that consume the meat or other food products.

Because it has been proven to be extremely difficult and inadequate to detect, by visual inspection alone, conveyor contaminate in meat and food being processed, food and drug regulations have been enacted to require metal and X-ray detection of conveyor fragments and other contaminants.

With the best available technology for magnetic and X-ray contaminate detection systems fully employed, there remains a need to improve the detectability of predictable process contaminates, such as conveyor systems fragments.

It is known to use magnetic metal detection for the identification of magnetic metal contaminates in food processing. However, many contaminates to processed food are non-magnetic. Conventional composite and plastic conveyor belt systems are non-magnetic. It is known to add magnetic steel powder with polypropylene and polyethylene resin to render the molded plastic conveyor fragments magnetically detectable.

Another way to detect conveyor fragments and particulate in meat and food being processed is by X-ray. However, X-ray is only effective if the X-ray image of the conveyor particulate is distinguishable from the meat or food product being conveyed. Therefore, it is necessary to include an X-ray opaque substance in sufficient proportions into the plastic conveyor resin to render a fragment of the conveyor X-ray detectable. Barium sulfate is known as an additive for use with polypropylene (PP) and polyethylene (PE) resin to render the molded plastic conveyor fragments detectable by X-rays.

It has recently been introduced to mix both powdered metal and barium sulfate as additives for use with polypropylene (PP) and polyethylene (PE) resin to render the molded plastic conveyor fragments both magnetically and X-ray detectable.

Each of these modified products, though magnetically and/or X-ray detectable, suffer from having significantly reduced performance characteristics that result from the combination of the barium sulfate and metal particles with the resin. In particular, these modified products are substantially more brittle. As a result, the detectable conveyor materials break easier and shed greater amounts of contaminant, and fail sooner than previous conveyor modules did.

In view of the foregoing, there continues to be a need for a plastic conveyor module that is both magnetically and X-ray detectable, and that has superior toughness

### SUMMARY OF THE INVENTION

The present invention, accordingly, provides a novel thermoplastic polymer that overcomes the serious drawbacks described above in the protein market conveyors. This new thermoplastic polymer, aliphatic polyketone resin, referred to herein as polyketone resin, does not swell with moisture, is unaffected by aqueous low pH acids, and withstands exposure to peroxy acids with early immeasurable effect. In addition to an ideal chemical resistance profile of polyketone resin, this polymer has frictional properties that are superior to polyacetal, polyamides and polyester in protein market conveyors. Finally, the physical properties of polyketone resin including melting point, molecular weight, percent mold shrinkage, and degree of crystallinity enable polyketone resin to be used in existing injection molds, avoiding the need for expensive capital investment for new injection molds.

As is typical with many polymers, polyketone resin is produced in high, medium, and low molecular weight ranges. In the protein market, it has been shown that high molecular weight polyketone resin provides the most desirable performance in friction, wear resistance, toughness retention, and high impact resistance. It is known to those skilled in the art that the melt flow rate of a polymer is inversely proportional to its molecular weight. Specifically, polyketone resin with a melt flow of less than 2 grams/10 minutes, measured at 240° C., performs well in protein conveyors, and a polyketone resin polymer with a melt flow rate of 2-4 grams/10 minutes is the most optimal flow and molecular weight.

Further, polyketone resin does not become brittle after repeated exposure to the acidic peroxy sanitizers now used in the protein market. Therefore, polyketone resin conveyors do not generate small pieces of plastic when they break, which inherently contributes to higher confidence in preventing foreign matter contamination in food.

In one preferred embodiment of the invention, a relatively high concentration of stainless steel powder, without barium, when added to the polyketone resin makes the belt modules both X-ray and magnetically (also referred to as “metal”) detectable. This “single additive” also reduces the issue of increased brittleness of the belt module. The single additive also reduces cost to produce. A “1.5 mm ferrous equivalent” may be obtained for belt modules. This means that if a piece of belt breaks off, the detection equipment can detect a piece that is approximately as small as a 1.5 mm metal sphere.

In accordance with principles of the invention, in the molding process, the polyketone resin is dried prior to molding to properly mold the parts. The resin is preferably “compounded” prior to molding instead of being “batch mixed” with the stainless steel powder and possibly colorant in the molding machine. “Compounding” entails properly mixing the polyketone resin and the stainless steel powder into homogeneous pellets. Thousands of such pellets are then melted in the injection process to form one or more belt modules. The mold pressure, mold temperature, water temperature, and cycle times are adjusted to properly mold the parts.

An advantage of the various embodiments of the disclosed invention is that the modules of a conveyor system are both X-ray and magnetically detectable. Another advantage of the disclosed invention is that it is less expensive to manufacture than other products with this capability. Another advantage of the disclosed invention is that it provides a conveyor with a higher modulus of elasticity than other X-ray and magnetically detectable conveyor products.

Another advantage of the disclosed invention is that it provides a conveyor with a higher impact resistance than other X-ray and magnetically detectable conveyor products, and will therefore resist breaking and spalling on incidental contact. Another advantage of the disclosed invention is that it provides a conveyor with a higher chemical resistance than other X-ray and magnetically detectable conveyor products, as such conveyor products are exposed to harsh chemicals during cleaning operations.

Another advantage of the disclosed invention is that it provides a conveyor with a higher abrasion resistance than other X-ray and magnetically detectable conveyor products, and will therefore wear longer. Another advantage of the disclosed invention is that it provides a conveyor that requires fewer USDA approvals for food grade application component ingredients.

Another advantage of the disclosed invention is that it provides a conveyor with a wide operating temperature range, from 32° F.-305° F. Another advantage of the disclosed invention is that it provides a conveyor with a low adhesion factor to protein fat, fatty meat, and animal oils, which results in the conveyor remaining cleaner longer and being easier to clean than other plastics.

In a further embodiment of the invention, barium sulfate is added to the polyketone resin with the stainless steel powder to enhance X-ray detectability and, surprisingly, to significantly reduce the quantity of stainless steel required to render small fragments of a conveyor module to be magnetically and X-ray detectable. Unlike a combination of barium sulfate as an additive to polypropylene (PP) and/or polyethylene (PE) resin, which rendered a module brittle with reduced magnetic and X-ray detectability, as discussed above, adding barium sulfate to a polyketone resin has been found to enhance magnetic and X-ray detectability of a module fragment without rendering the module brittle.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objects and features of the invention will become more readily understood from the following detailed description and appended claims when read in conjunction with the accompanying drawings in which like numerals represent like elements.

FIG. 1 is a flow chart depicting steps at a high level for producing material for forming conveyor modules in accordance with principles of the invention.

FIG. 2 is a flow chart depicting, in greater detail, one step of the flow chart of FIG. 1 in accordance with principles of the invention.

### DETAILED DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Unless indicated otherwise, ratios and percentages of elements constituting a compound, composition, or mixture are given with reference to the total weight of the compound, composition, or mixture. The acronym ASTM refers to the American Society for Testing and Materials, an international standards organization that develops and publishes voluntary consensus technical standards for a wide range of materials, products, systems, and services. As used herein, the term “polyketone resin” includes the compounds “polyketone”, POKETONE®, “POK”, and “POK resin”.

It has been determined through extensive experimentation that a conveyor module can be produced that is both X-ray and magnetically detectable and that retains superior performance characteristics over conventionally known modules designed for this purpose. Such a conveyer module can be produced by forming the module using a thermoplastic polymer, namely, a polyketone resin, such as produced by Hyosung Chemical in Seoul, South Korea, under the tradename of POKETONE®, also referred to as “POK”. A terpolymer polyketone resin is preferred, or, alternatively, an aliphatic polyketone resin may be used. A terpolymer polyketone resin is preferred, comprising ethylene, carbon monoxide, and propylene in an approximate ratio of 47.5:47.5:5, respectively, in the polymer backbone. The propylene preferably constitutes about 2% to 12% of the terpolymer polyketone resin, with the ratio of carbon monoxide to ethylene preferably being approximately 1:1.

The preferred melt flow rate for the polyketone resin is about 2.5 g/10 minutes measured at 240° C., per ASTM D1238. Such a melt flow rate imparts an optimal balance of processability and mechanical toughness of the final article. Alternatively, the melt flow rate may vary in an operable range of 2.5-70 g/10 minutes, measured at 240° C., per ASTM D1238.

In a further embodiment of the invention, the magnetic and/or the X-ray susceptibility and detectability of a small fragment of a conveyor module formed from polyketone resin may be enhanced by compounding a mixture of the polyketone resin with a ferrous metal powder, such as iron powder, iron alloys, any 400 series stainless steel powder (preferably 409 or 430 stainless steel), any high nickel content stainless steel powder, such as a 300 series stainless steel (e.g., 304, 316, or 320), and the like. Polyketone resin accepts a higher weight percent of stainless steel additive compared to other plastics, and it still retains a higher percentage of mechanical properties with the stainless steel added. The amount of ferrous metal powder should be small enough so as not to materially affect properties associated with the function of the polyketone resin, but be large enough to enhance the magnetic and/or X-ray susceptibility and detectability of the conveyor module. Accordingly, in one preferred embodiment of the invention, the amount of 400 series stainless steel powder effective for enhancing both magnetic and X-ray detectability, by weight of the mixture with polyketone resin, is from about 8% to about 60%, typically, from about 12% to about 45%, and preferably, from about 15% to about 30%:

In a further embodiment of the invention, the X-ray detectability of small fragments of a conveyor module formed from polyketone resin may also be enhanced by compounding a mixture of the polyketone resin with barium sulfate powder, preferably comprising barium sulfate particles having a size from about 0.5 to about 500 microns and, typically, from about 1 to about 100 microns and, preferably, about 1 micron in diameter. Barium sulfate may be added to the polyketone resin without rendering the polyketone resin brittle, which is surprising since barium sulfate renders polypropylene (PP) resin and polyethylene (PE) resin brittle. The amount of barium sulfate powder should be small enough so as not to materially affect properties associated with the function of the polyketone resin, but be large enough to enhance the X-ray detectability of the conveyor module. Accordingly, the amount of barium sulfate powder effective to enhance X-ray detectability, by weight of the mixture with polyketone resin, is from about 2% to about 50%, and typically, from about 10% to about 40%, and preferably, from about 20% to about 26%.

In a still further embodiment of the invention, both the magnetic and X-ray detectability of small fragments of a conveyor module formed from polyketone resin may be further enhanced by compounding a mixture of the polyketone resin with both a ferrous metal powder (e.g., 400 series stainless steel powder) and barium sulfate powder. The amount of stainless steel powder and barium sulfate powder should be small enough so as not to materially affect properties associated with the function of the polyketone resin, but be large enough to enhance the magnetic susceptibility and X-ray detectability of the conveyor module. Accordingly, with barium sulfate added to the mixture for X-ray detectability, the amount of 400 series stainless steel powder needed for enhancing magnetic detectability, by weight of the mixture with polyketone resin, would be from about 4% to about 40%, and typically, from about 6% to about 30%, and preferably, from about 8% to about 20%.

The 400 series stainless steel powder is preferably 409 stainless steel powder or 430 stainless steel powder. The 409 and 430 stainless steel powders are preferred as they allow for the best balance of magnetic detection at the lowest weight percent in the polymer, while providing very good oxidation resistance. The 300 series stainless steel powder, which is traditionally not attracted to a magnet, could be used, but the loading (weight percent) for metal detectability would need to be increased to an amount ranging from about 15% to about 60% by weight of the mixture and, typically, from about 20% to about 50% by weight of the mixture and, preferably, from about 24% to about 40% by weight of the mixture. To match, for example, 18% by weight of 400 series metal detection, 300 series would need to be added at 26% by weight. However, at 26% loading, both cost and mechanical performance are adversely affected.

The amount of 300 series stainless steel powder effective for enhancing magnetic and X-ray detectability, by weight of the mixture with polyketone resin, would be from about 18% to about 60%, and typically, from about 23% to about 43%, and preferably, from about 26% to about 35%.

Iron powder works extremely well for magnetic detection, but is highly prone to oxidation (rusting) in use and can stain food on a conveyor. Iron oxide black (Fe+3) provides magnetic and X-ray detection action, and doesn't stain food, but it renders the polyketone resin black which is not acceptable by the USDA in food plants. Amounts of iron powder effective to enhance magnetic detectability, by weight of the mixture with polyketone resin, are from about 0.3% to about 50%, and typically, from about 0.4% to about 40%, and preferably, from about 0.5% to about 30%.

The stainless steel powder preferably has a particle size of about 100 mesh or smaller, or, alternatively, in the range of 100 mesh to 325 mesh. Larger particle size powders, e.g., in the range of 60-80 mesh (170-250 microns), will decrease mechanical impact incrementally compared to 100-325 mesh powders, while still imparting useful detectability qualities in both X-ray and metal detection devices. Alternatively, ultra-fine particle sizes, less than 325 mesh, pose dust explosion and fire hazards for the compounder, as well as higher cost than larger size particles.

Polyketone resin having a melt flow rate in the range of about 4-90 g/10 minutes measured at 240° C., per ASTM D1238, or preferably about 6 g/10 minutes, works better for compounding with stainless steel powder.

The various combinations of stainless steel powder and barium sulfate powder will be referred to herein collectively as an “additive”.

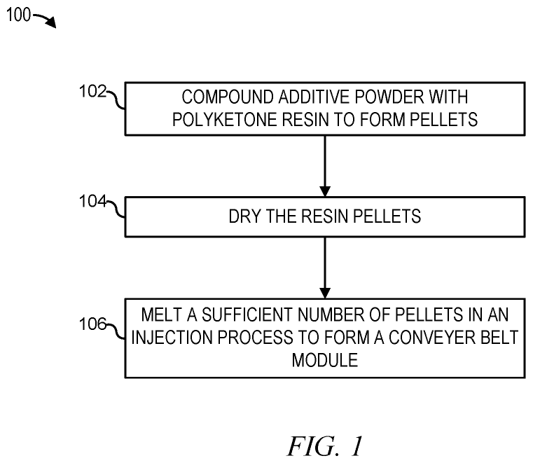

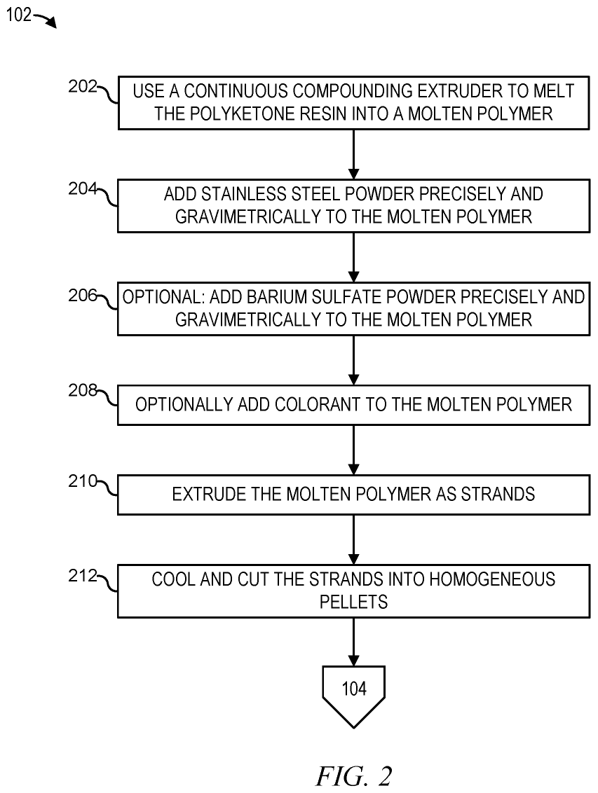

FIGS. 1 and 2 are flow charts 100 and 102 setting forth steps in a method for making a mixture of polyketone resin with an additive for use in forming conveyor modules. Accordingly, in FIG. 1, step 102, a given amount of an additive powder is preferably extrusion compounded into the polyketone resin to form homogeneous, cylindrical pellets, or the like. Extrusion compounding is preferred over injection molding because injection molding machines do not provide the same high degree of homogeneity in distributive mixing of additives into polymer. Also, phase separation readily occurs when trying to blend plastic resin and the considerably more dense additive. Further, injection molding machines do not allow for gravimetric addition of additives, like an extrusion compounder. Step 102 is described in further detail below with respect to FIG. 2.

In step 104, the resin pellets are dried prior to molding. Drying the resin, in a manner well-known to those skilled in the art, prior to molding is necessary for creating a blemish free exterior surface of the molded conveyor module.

The initial samples using polyketone resin having a melt flow rate of 2.5 g/10 minutes were molded into test coupons and exhibited exceptional strength and impact. But when conveyor modules were attempted to be molded, the compositions were so viscous that complete parts could not be formed, or the surface quality was too rough or the combination of heat pressure of the molding process caused the composition to chemically degrade.

Only when a high melt flow rate (i.e., greater than 2.5 g/10 minutes flow) polyketone resin was selected was it possible to make acceptable parts. The finished articles exhibited surprisingly high impact resistance and strength almost comparable to the polyketone resin without the additive.

In step 106, a number of pellets, sufficient to form a conveyor belt module, are melted in an injection process to form the conveyor belt module. The mold pressure, molding temperature, water temperature, cycle times, and other such parameters to perform this step are considered to be well-known to those skilled in the art, and so will not be described in further detail herein.

With reference to FIG. 2, flow chart 102 sets forth details of step 102 depicted above with respect to FIG. 1 to compound additive powder with polyketone resin to form pellets. Accordingly, in step 202, a twin screw, or optionally single screw, continuous compounding extruder is preferably used to melt polyketone resin into a molten polymer. It may be appreciated that other forms of melt mixing, such as batch mixing, may be used in step 202, as known to those skilled in the art. In step 204, stainless steel powder, in quantities discussed above, is added precisely and gravimetrically, or alternatively, volumetrically, to the molten polymer. In step 206, barium sulfate powder, in quantities discussed above, is optionally added precisely and gravimetrically, or alternatively, volumetrically, to the molten polymer. Alternatively, prior to step 204, stainless steel powder and barium sulfate powder may be mixed and added together in step 204, rendering step 206 moot. In step 208, colorant is optionally added to the molten polymer. In step 210, the molten polymer is preferably extruded as strands, which may, for example, be diced into pellets, or directly die-face cut into pellets. In step 212, the strands are cooled and preferably cut (e.g., diced, chopped) into homogeneous pellets, which pellets are preferably cylindrical pellets. Execution then proceeds to step 104 (FIG. 1).

By use of the method described above with respect to FIGS. 1 and 2, conveyor modules may be formed, small fragments of which are detectable by X-ray and by magnetic sensors (e.g., Hall effect sensor, magnetometer, and the like), meeting a 1.5 mm ferrous calibration standard. Further, compared to the prior art, such modules have been shown to have higher impact resistance, higher abrasion resistance, higher chemical resistance, and a lower coefficient of product release.

It will be readily apparent to those skilled in the art that the general principles defined herein may be applied to other embodiments and applications without departing from the spirit and scope of the present invention. By way of example but not limitation, if magnetic detection is not needed, the additive in steps 204 and 206 may consist of barium sulfate powder (with no stainless steel powder) to thereby enable X-ray detection only. Or, alternatively, if X-ray detection is not needed, the additive in steps 204 and 206 may consist of stainless steel powder (with no barium sulfate powder) to thereby enable magnetic detection only. Other paramagnetic metals may be used in place of stainless steel and other ferrous metals, such as Group 8 metals, including ruthenium and osmium, and Group 10 metals, including the triad of nickel, palladium and platinum. While such other paramagnetic metals are technically susceptible to X-ray and magnetic detection, they are costly and/or pose health issues.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A conveyor module, small fragments of which are detectable by X-ray and magnetic sensors comprising:
a compounded mixture of a polyketone resin, ferrous metal powder, and barium sulfate powder;
wherein the amount of ferrous metal powder is small enough so as not to materially affect properties associated with the polyketone resin while being large enough to enhance magnetic susceptibility of the small fragments of the conveyer module; and
wherein the amount of barium sulfate powder is small enough so as not to materially affect properties associated with the polyketone resin while being large enough to enhance X-ray detectability of the small fragments of the conveyer module.

2. The conveyor module of claim 1,
wherein the ferrous metal powder is iron powder constituting about 0.3% to about 50% by weight of the compounded mixture; and
wherein the barium sulfate powder constitutes about 2% to about 50% by weight of the compounded mixture.

3. The conveyor module of claim 1,
wherein the ferrous metal powder is a 400 series stainless steel powder constituting about 4% to about 40% by weight of the compounded mixture; and
wherein the barium sulfate powder constitutes about 2% to about 50% by weight of the compounded mixture.

4. The conveyor module of claim 1,
wherein the ferrous metal powder is a 300 series stainless steel powder constituting about 15% to about 60% by weight of the compounded mixture; and
wherein the barium sulfate powder constitutes about 2% to about 50% by weight of the compounded mixture.

5. The conveyor module of claim 1, wherein the polyketone resin is one of an aliphatic polyketone resin and a terpolymer polyketone resin.

6. The conveyor module of claim 1, wherein the polyketone resin is a terpolymer polyketone resin comprising ethylene, carbon monoxide, and propylene in an approximate ratio of 45:49:6, respectively.

7. The method of claim 1, wherein the polyketone resin is a terpolymer polyketone resin comprising ethylene, carbon monoxide, and propylene, wherein the propylene constitutes from 2% to 12% of the terpolymer polyketone resin.

8. The conveyor module of claim 1, wherein the melt flow rate for the polyketone resin is about 2.5-70 g/10 minutes measured at 240° C., per ASTM D1238.

9. The conveyor module of claim 1, wherein the ferrous metal powder is a stainless steel powder having a particle size of 100 mesh or smaller.

10. The conveyor module of claim 1, wherein the barium sulfate is a powder having a particle size of between about 1 micron and 100 microns.

11. A method of making a conveyor module, small fragments of which are detectable by X-ray and magnetic sensors, the conveyor module being formed from a polyketone resin, the method comprising compounding a ferrous metal powder and a barium sulfate powder into the polyketone resin prior to formation of the conveyor module.

12. The method of claim 11,
wherein the amount of the ferrous metal powder is stainless steel powder in an amount small enough so as not to materially affect properties associated with the polyketone resin while being large enough to enhance magnetic susceptibility of the small fragments of the conveyer module; and
wherein the amount of barium sulfate powder is small enough so as not to materially affect properties associated with the polyketone resin while being large enough to enhance X-ray detectability of the small fragments of the conveyer module.

13. The method of claim 11, wherein the step of compounding comprises steps of:
melting the polyketone resin into a molten polymer;
adding the ferrous metal powder to the molten polymer; and
adding the barium sulfate powder to the molten polymer.

14. The method of claim 11, wherein the step of compounding comprises steps of:
using an extruder to melt the polyketone resin into a molten polymer;
adding the stainless steel powder to the molten polymer; and
adding the barium sulfate powder to the molten polymer.

15. The method of claim 11, wherein the stainless steel powder is a 400 series stainless steel powder constituting about 4% to 40% by weight of the compounded mixture.

16. The method of claim 11, wherein the polyketone resin is one of an aliphatic polyketone resin and a terpolymer polyketone resin.

17. A conveyor module, small fragments of which are detectable by X-ray and magnetic sensors comprising:
a compounded mixture of a polyketone resin and a stainless steel powder, wherein the amount of stainless steel powder is small enough so as not to materially affect properties associated with the polyketone resin while being large enough to enhance magnetic susceptibility of the small fragments of the conveyer module.

18. The conveyor module of claim 17, wherein the stainless steel powder is a 400 series stainless steel powder constituting about 8% to about 60% by weight of the compounded mixture.

19. The conveyor module of claim 17, wherein the polyketone resin is one of an aliphatic polyketone resin and a terpolymer polyketone resin.

20. The conveyor module of claim 17, wherein the polyketone resin is a terpolymer polyketone resin comprising ethylene, carbon monoxide, and propylene in an approximate ratio of 45:49:6, respectively.

21. The conveyor module of claim 17, wherein the polyketone resin is a terpolymer polyketone resin comprising ethylene, carbon monoxide, and propylene, wherein the propylene constitutes from about 2% to about 12% of the terpolymer polyketone resin.

22. The conveyor module of claim 17, wherein the melt flow rate for the polyketone resin is about 2.5-70 g/10 minutes measured at 240° C., per ASTM D1238.

23. The conveyor module of claim 17, wherein the ferrous metal powder is a stainless steel powder having a particle size of 100 mesh or smaller.

24. A method of making a conveyor module, small fragments of which are detectable by X-ray and magnetic sensors, the conveyor module being formed from a polyketone resin, the method comprising compounding a stainless steel powder into the polyketone resin prior to formation of the conveyor module.

25. The method of claim 24, wherein the amount of the stainless steel powder is small enough so as not to materially affect properties associated with the polyketone resin while being large enough to enhance magnetic susceptibility of the small fragments of the conveyer module.

26. The method of claim 24, wherein the stainless steel powder is a 400 series stainless steel powder constituting about 8% to 60% by weight of the compounded mixture.

27. The method of claim 24, wherein the polyketone resin is one of an aliphatic polyketone resin and a terpolymer polyketone resin.

28. The method of claim 24, wherein the step of compounding comprises steps of:
melting the polyketone resin into a molten polymer; and
adding the ferrous metal powder to the molten polymer.

29. The method of claim 24, wherein the step of compounding comprises steps of:
using an extruder to melt the polyketone resin into a molten polymer; and
adding the stainless steel powder to the molten polymer.

30. The method of claim 24, wherein the step of compounding comprises steps of:
using a continuous compounding extruder to melt the polyketone resin into a molten polymer; and
adding the stainless steel powder to the molten polymer.
